(19) United States
(12) Patent Application Publication
(10) Pub. No.: US 2013/0090952 A1
(43) Pub. Date: Apr. 11, 2013

(54) SYSTEM AND METHOD FOR TRANSFER CONTROL

(71) Applicants: Prakash Upadhyayula, Plainfield, IL (US); Vinay Kulkarni, Woodland Hills, CA (US); Venkatesh Subramaniam, Glen Allen, VA (US); Ramesh Eevani, Monmouth Junction, NJ (US); Widya Harianto, Woodland Hills, CA (US); Janey Daniel, Valencia, CA (US); Sanjith Rai, Princeton, NJ (US); Suparna Dutta, Charlotte, NC (US)

(72) Inventors: Prakash Upadhyayula, Plainfield, IL (US); Vinay Kulkarni, Woodland Hills, CA (US); Venkatesh Subramaniam, Glen Allen, VA (US); Ramesh Eevani, Monmouth Junction, NJ (US); Widya Harianto, Woodland Hills, CA (US); Janey Daniel, Valencia, CA (US); Sanjith Rai, Princeton, NJ (US); Suparna Dutta, Charlotte, NC (US)

(73) Assignee: WELLPOINT, INC., Chicago, IL (US)

(21) Appl. No.: 13/615,729

(22) Filed: Sep. 14, 2012

Related U.S. Application Data
(60) Provisional application No. 61/535,501, filed on Sep. 16, 2011.

(51) Int. Cl. G06Q 40/08

(52) U.S. Cl. CPC G06Q 40/08
USPC 705/4

(57) ABSTRACT

Systems, methods and computer-readable media for transferring control over input of data to electronic forms. An electronic insurance application form including a plurality of form fields for receiving input data is displayed to a consumer. Control over input of data to the form fields is associated with an identifier of the consumer in an access control table for the electronic insurance application form. A request to transfer control over input of data to the form fields to an insurance agent is received from the consumer. The access control table for the electronic insurance application form is updated to associate control over input of data to the form fields with an identifier of the insurance agent. Data describing the electronic insurance application form is transferred to the insurance agent.

### CROSS REFERENCE TO RELATED APPLICATIONS

This application claims priority to U.S. Provisional Patent Application No. 61/535,501, filed Sep. 16, 2011, the entirety of which is incorporated herein by reference.

### FIELD OF THE INVENTION

The systems and methods described herein relate to transferring control of electronic documents in an online environment.

### BACKGROUND

The healthcare insurance sales process is complex as it involves many business functions (e.g., quoting, rating, eligibility check, underwriting, enrollment, and post-enrollment processes such as payment processing). There is a need to optimize use of resources in the sales process and increase the ratio of converting prospects into real customers.

Many internet portals that provide for an on-line enrollment process lose customers either because of usability issues and/or because any assistance provided to the consumer in connection with the enrollment process is ineffective. Offering assistance via telephone using customer service representatives or live chat functionality is expensive to support, as it requires internal agents being available at all times to help. Thus, many websites offer live chat and phone support only during business hours, which is not entirely helpful to customers who shop at their convenience, including off-business hours.

### SUMMARY OF EMBODIMENTS OF THE INVENTION

The present invention is directed to systems, methods and computer-readable media for transferring control over input of data to electronic forms. An electronic insurance application form including a plurality of form fields for receiving input data is displayed to a consumer. Control over input of data to the form fields is associated with an identifier of the consumer in an access control table for the electronic insurance application form. A request to transfer control over input of data to the form fields to an insurance agent is received from the consumer. The access control table for the electronic insurance application form is updated to associate control over input of data to the form fields with an identifier of the insurance agent. Data describing the electronic insurance application form is transferred to the insurance agent.

In some embodiments, the consumer requests to transfer control over input of data to the form fields to a specific insurance agent identified by the consumer and, in other embodiments, the request is to transfer to a next available insurance agent.

In some embodiments, an activity for the insurance agent relating to completion of the electronic insurance application form in a sales force automation system.

In some embodiments, at least some data has been input into the form fields of the electronic insurance application prior to transfer to the insurance agent.

In some embodiments, a request to transfer control over input of data to the form fields back to the consumer is received from the insurance agent. In this case, the access control table for the electronic insurance application form is updated to associate control over input of data to the form fields with the identifier of the consumer, and data describing the electronic insurance application form is transferred to the consumer. In some embodiments, at least some data has been input into the form fields of the electronic insurance application form prior to transfer back to the consumer.

In some embodiments, a request to transfer control over input of data to the form fields to another insurance agent is received from the insurance agent. In this case, the access control table for the electronic insurance application form is updated to associate control over input of data to the form fields with an identifier of the other insurance agent and data describing the electronic insurance application form is transferred to the other insurance agent.

In some embodiments, at least some data has been input into the form fields of the electronic insurance application form prior to transfer to the other insurance agent. Also, in some embodiments, an activity for the other insurance agent relating to completion of the electronic insurance application form is created in a sales force automation system.

### BRIEF DESCRIPTION OF THE DRAWINGS

FIG. 1 illustrates exemplary system components of one embodiment of the present invention;

FIG. 2 also illustrates exemplary system component of one embodiment of the present invention;

FIG. 3 also illustrates exemplary system component of one embodiment of the present invention;

FIG. 4A is a flow diagram illustrating an exemplary process flow in accordance with one embodiment of the present invention;

FIGS. 4B-4I are user interfaces that may be employed in connection with an exemplary embodiment of the invention;

FIG. 5 is a flow diagram illustrating an exemplary process flow in accordance with one embodiment of the present invention;

FIG. 6 is a flow diagram illustrating an exemplary process flow in accordance with one embodiment of the present invention;

FIG. 7 is a flow diagram illustrating an exemplary process flow in accordance with one embodiment of the present invention; and

FIG. 8 is a diagram illustrating exemplary hardware and software component that may be used in connection with an exemplary embodiment of the present invention.

### DETAILED DESCRIPTION

The systems and methods described herein (referred to as the “online store”) relate to a collection of web applications and supporting web services designed to enable consumers to search for a health care product (e.g., Senior populations to applying for Medicare plans), render quotes on the identified plans and, finally, to enroll online, referred to as the “online store”. Consumers applying for health care insurance in an online environment may need assistance in completing an application. The technology described herein enables an asynchronous dialog between prospective customers and sales resources with the objective of completing an application in the most efficient manner. The systems and methods allow the consumer to transfer control of the online application to a customer service representative (CSR) (i.e., the next available CSR or one chosen by the consumer). The CSR can either continue and complete the application or transfer it back to a consumer, as needed. Transfer can also occur between two CSRs. The transfer capability also allows CSRs to recall a transfer, e.g., to a consumer or another agent, as long as the application has not been submitted. Transfers between and among CSRs and consumers can occur multiple times, in accordance with the systems and methods described herein. In order to gain control over the application, the CSR does not log into the online store. Instead, the application is routed to the CSR as a new item on the sales force automation (SFA) system, described in more detail below.

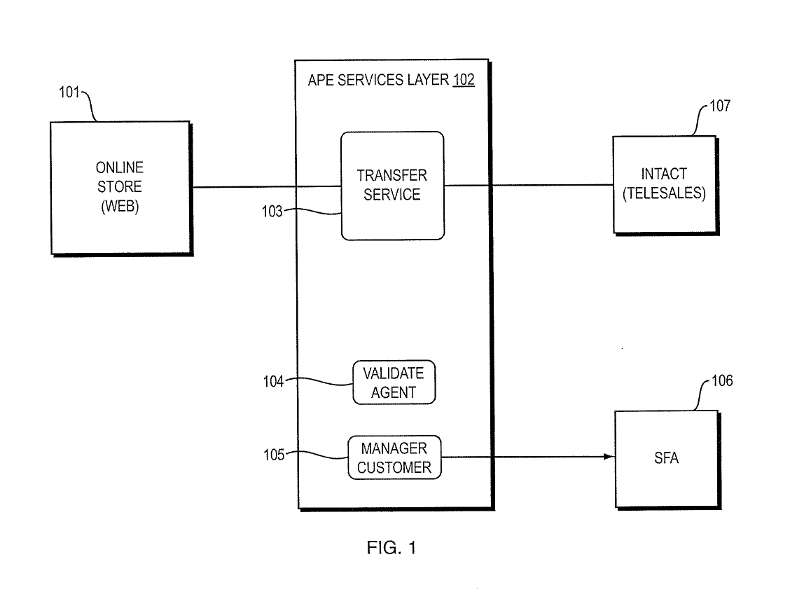

FIG. 1 provides a high level overview of the environment in which the invention operates. The online store is presented by way of a web application 101. Calls from the web application 101 are made to the application processing engine (APE) 102. APE 102 includes a transfer service software module 103, as well as a validation module 104, used to validate CSRs, and a consumer management module 105, that interfaces with SFA system 106. APE 102 also interfaces with application capture system 107. Application capture system 107 is used by internal agents/CSRs to take control over (and fill out) an application from a consumer or another agent.

In one embodiment, the system includes two user interfaces (each, a UI). One is an external-facing UI: This is used by consumers navigating the online store via the Internet. The other is an internal-facing UI. This is used by internal CSRs in connection with telesales operations. Both of UIs communicate with a collection of Web Services, i.e., APE 102, to persist and retrieve enrollment data.

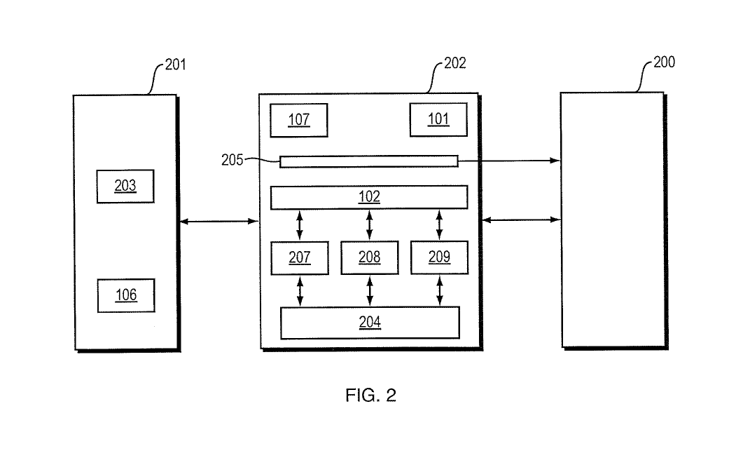

FIG. 2 is a diagram also illustrating an exemplary configuration for components of the system that provides for the functionality described herein. Online store interface 200 is used by consumers and external agents to employ the functionality of the online store web application 101. Electronic business component 202 is a collection of web-based applications and web services used to implement the online store and communicate information received through the online store to the other system components, such as enterprise CRM component 201. Enterprise CRM component 201 includes SFA system 106, as well as lead management application 203. Electronic business component 202 implements both the application capture system 107 (the internal-facing UI) and web application 101 (the external-facing UI). Online store application 205 provides for functionality to support all aspects of the online store, including searching for plans, quoting, and enrollment. Online store application 205 interfaces with APE 102. APE 102 interfaces with a number components, including rating component 207, billing component 208, and imaging component 209, to allow for enrollment, through enrollment component 204, which processes completed applications.

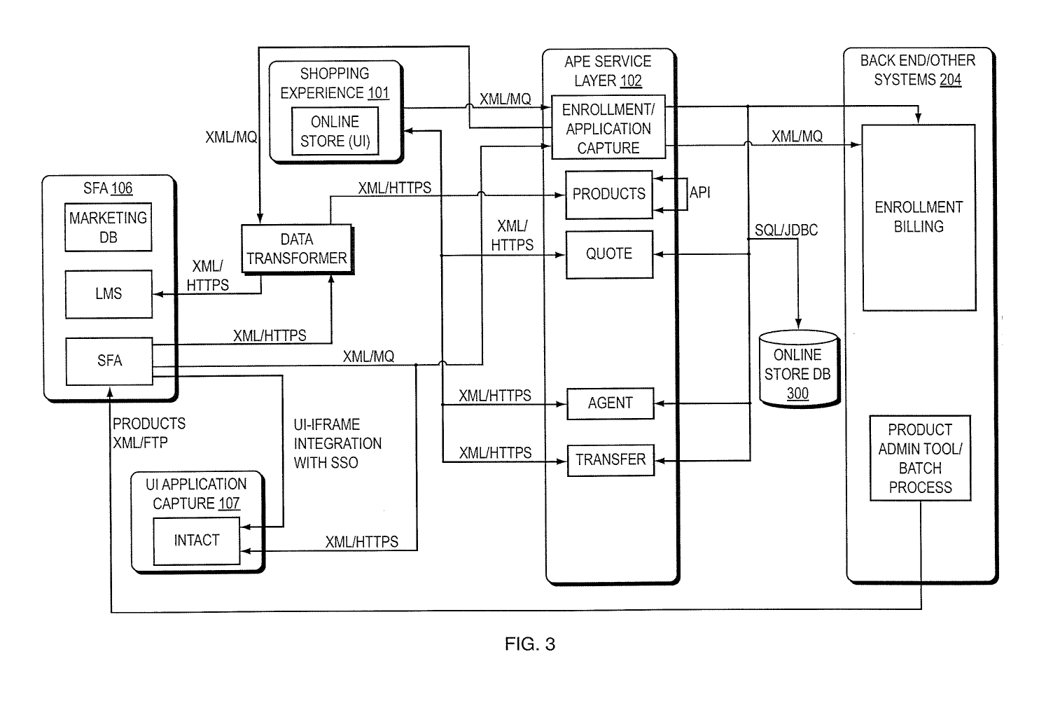

FIG. 3 provides a further view of how the various system components are integrated to deliver and support the online store functionality. The web services and data base calls between and among components are illustrated in this figure. Components include application capture system 107, SFA component 106, web application 101, APE 102, enrollment component 204 (i.e., back end systems that handle processing of completed applications), and online database 300, for storing data collected through the online store.

In one exemplary embodiment, the transfer service interface is invoked via SOAP/HTTPS and the input/output is in XML. Generally, the user clicks on the transfer button displayed on the UI, the transfer service determines the type of transfer, checks the status of the application, and checks the lead distribution status before executing the transfer, as described in more detail below.

There are three types of transfers, in the exemplary embodiment. In connection with the consumer to CSR transfer, the customer clicks on the button on the UI indicating a transfer. If the customer is working with an agent/CSR, he enters the email address of the internal agent. The agent look up service obtains the agent identifier (Agent Id) of the agent requested by the customer if the customer has entered a valid email address. The application data is updated in the online store database (database 300 of FIG. 3) with the Agent Id and flagged as agent assisted. The service checks the lead status (e.g., the status of the sales lead, such as open, closed, or worked upon). If there are any leads with outstanding lead distribution status, the ManageCustomerApplication service calls for the Application Control Number (ACN) (a unique ID associated with each enrollment application) associated with the outstanding leads. The lead information associated with that application will be persisted in the OnHoldCalls table. Because there could be multiple ManageCustomerApplications service calls done on a particular ACN, only the last call will be put on-hold. All OPEN on-hold calls will be executed only when the lead distribution for the latest lead is received. Once the on-hold call is executed successfully, the Execute TimeStamp will be updated, the status will be set to CLOSED and the Close Timestamp will also be updated accordingly to ensure that it will not be executed again. The application is transferred via AppHandOver web service with an event type of Control Transfer. This allows the SFA system 106 to create an activity for the assigned agent, or look up an available agent, and return the assigned agent details. The assigned agent details are updated in database 300 of FIG. 3. The customer is also notified via email. The ownership of the application is updated in the Access Control Table (online store database 300 of FIG. 3) from consumer to agent.

In an agent to consumer transfer, because the lead has been distributed, the agent is already assigned. Otherwise, the process is the same as that described above in the consumer to agent transfer. The agent is asked for the customer's email identifier. The application ownership is updated in the access control table from the agent to the consumer. Any Recall Application activity by the internal agent via application capture system 107 will be executed without the need to check the lead distribution status (i.e., because the recall application activity has already had an internal agent assigned, it does not depend on the lead distribution status).

In the agent to agent transfer scenario, the transfer occurs in the same manner as described above, except that the Agent ID on the Access Control Table is updated with the transferee Agent ID.

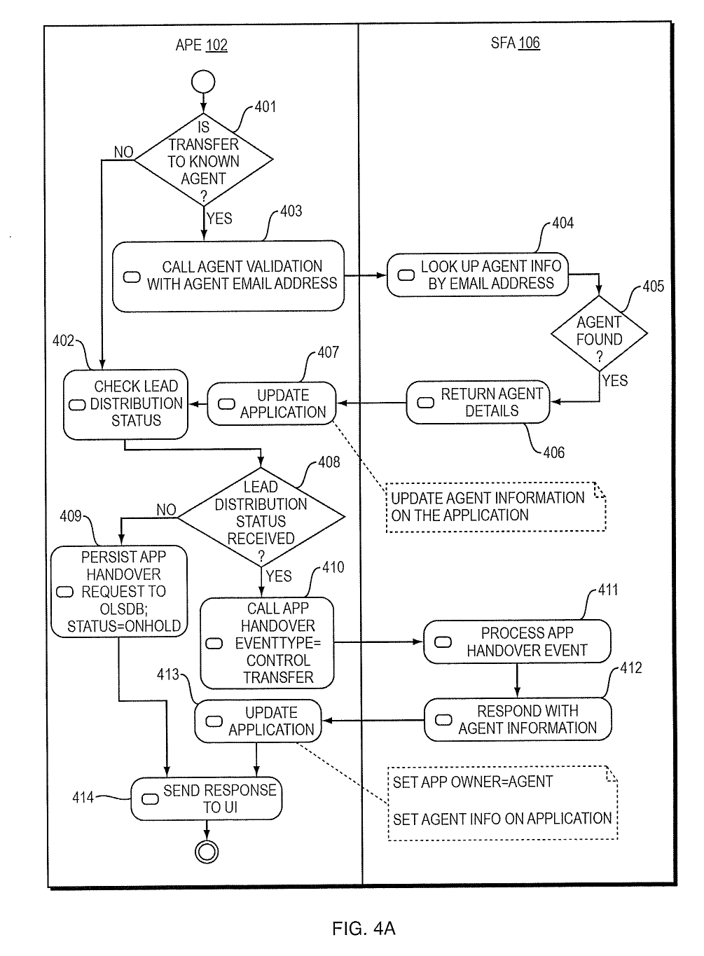

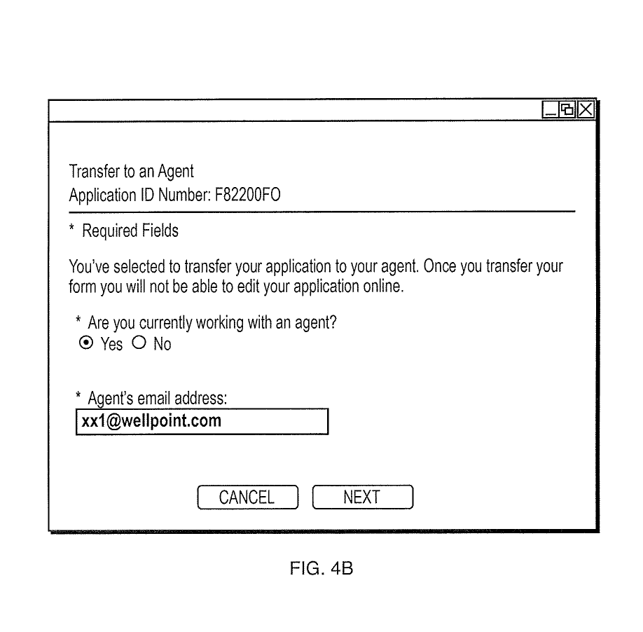

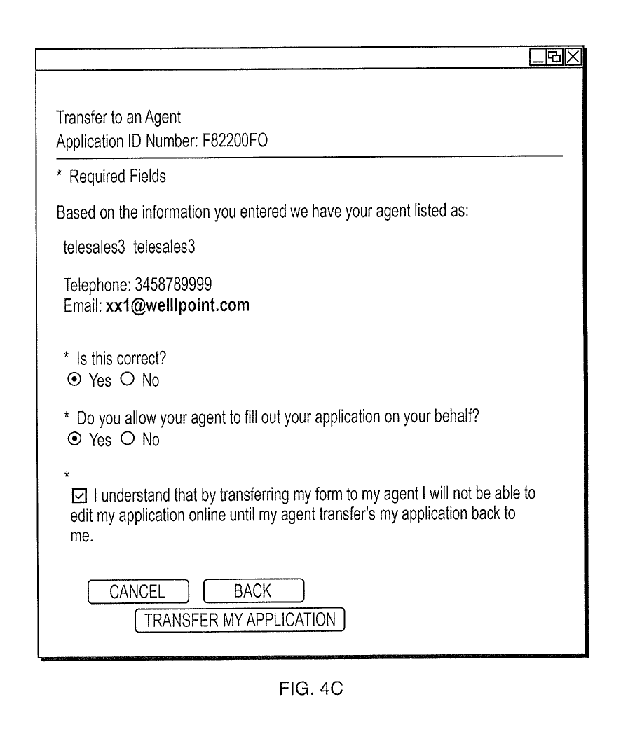

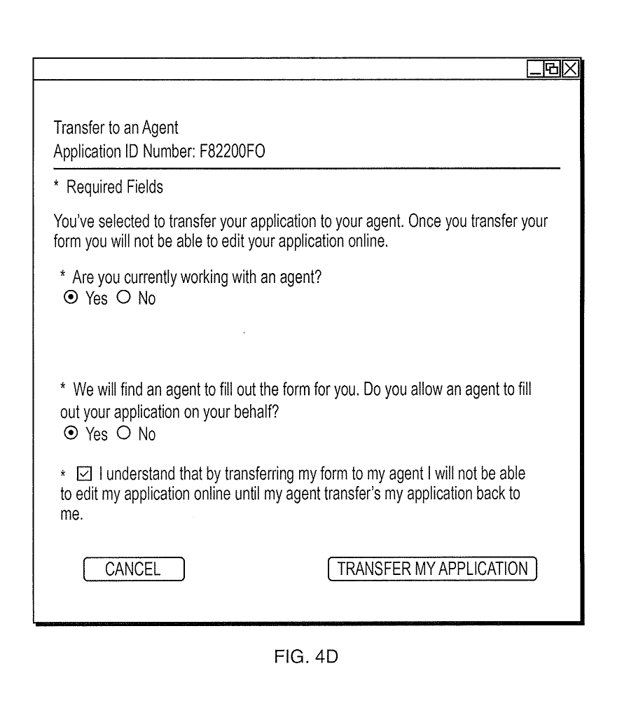

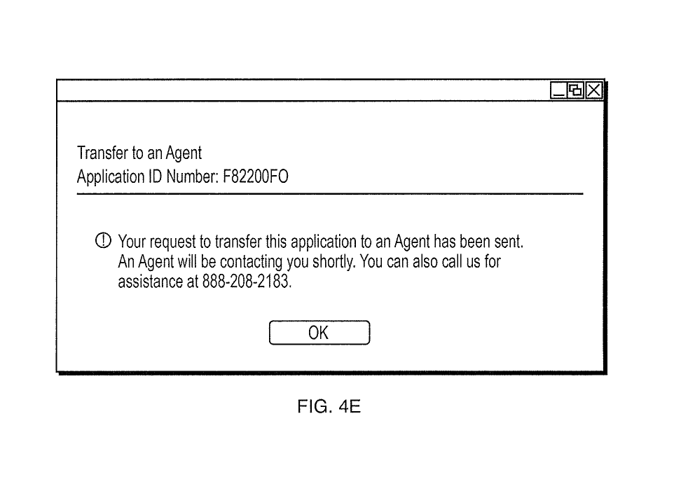

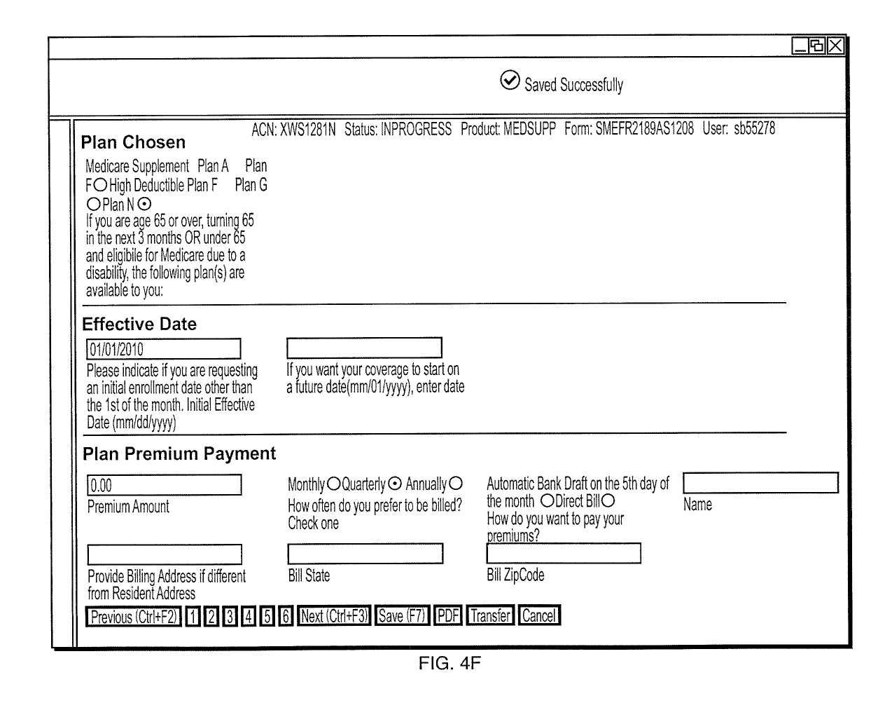

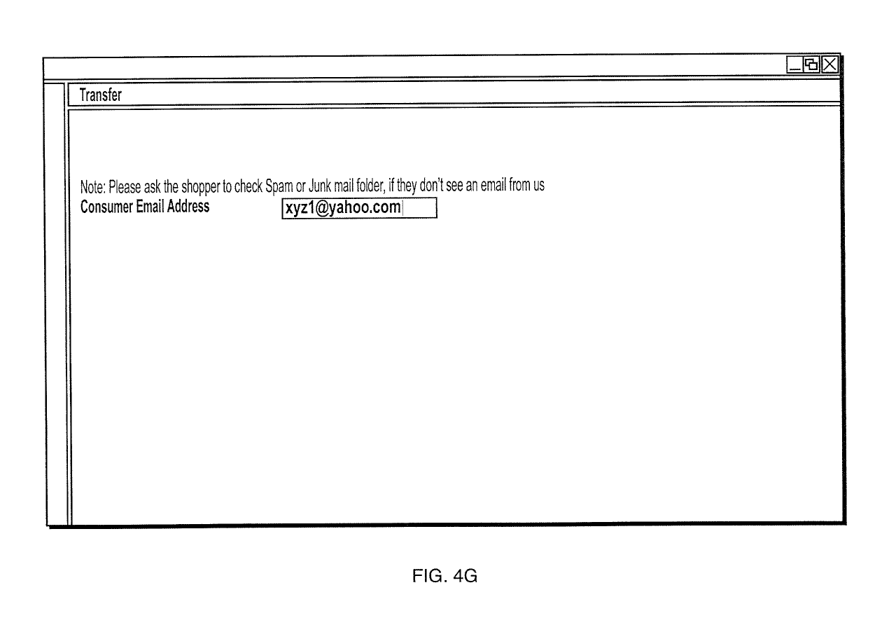

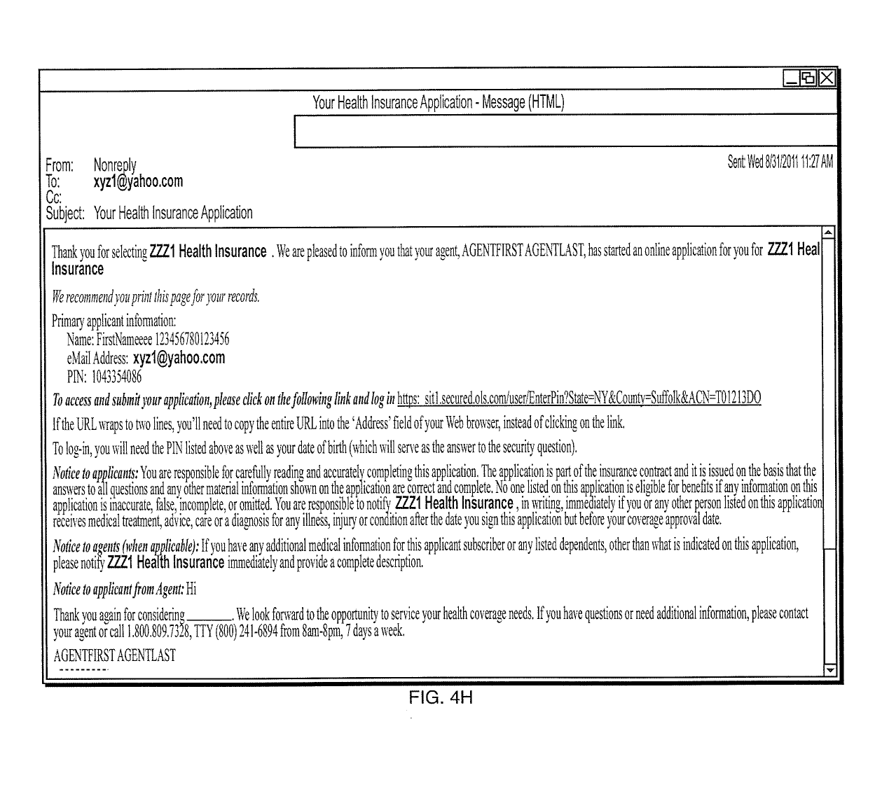

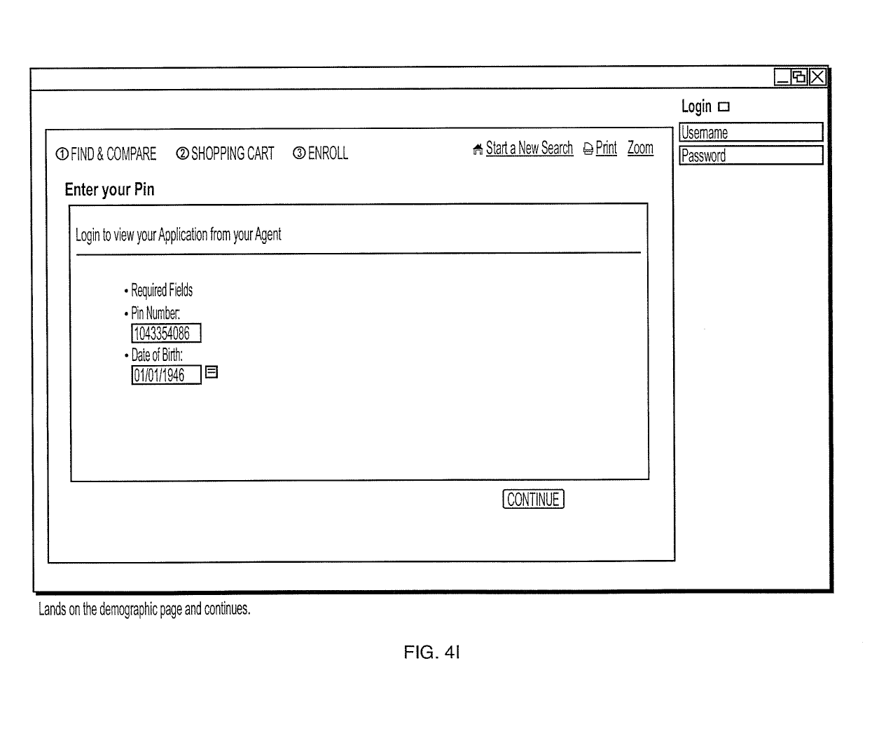

A flow diagram illustrating an exemplary transfer is shown with reference to FIG. 4A. The consumer clicks the transfer button of the UI. The system prompts the consumer to enter an email address for the agent (Agent ID) of the consumer's choosing, or to indicate that the consumer does not have a particular agent to assist him, in step 401 (see FIG. 4B). If the consumer enters an email address of an agent, the agent email address is used to call the Agent Validation service in step 403. In step 404, the email address is used to look up the agent information in SFA component 106. In step 405, the agent is found, and in step 406, the agent details are returned (see FIG. 4C). The application is updated, in step 407, with the agent details, which information is stored in the online store database 300. Returning again to step 401, if the consumer does not indicate an agent email address but had indicated that he wants an agent to fill out the application on his behalf (see FIG. 4D), in step 402, the lead distribution status is checked. In step 408, the system checks to see if the lead has been distributed (either to the agent of the consumers choosing or another agent in line to be distributed a lead) by the lead management system (e.g., the system checks the flag on the Leads table in the online store database 300 to see if there is a response). If the lead has been distributed, in step 410, the Application Handover service is invoked with an event type of Control Transfer. In step 411, the Application Handover event is processed. In step 412, a response with the agent information is received. The Application Handover sets up the agent with the application ACN so the agent can see the activity in his queue and passes the agent back so that the Access Control List can be updated with the agentId. In connection with step 412, the Application Handover service creates an activity (i.e., to contact the consumer regarding completion of the application) on the SFA component 106 for the assigned agent or will search for an available agent. Once the Application Handover to the assigned agent or an available agent is successful, in step 413, the ownership is updated on the Access Control Table column from Access Type—owner to a Access Type—reviewer. The Access Control Table is maintained on the APE 102 side of the online store database 103, in one embodiment. A new row is added within the Access Control Table for the same ACN. When multiple transfers occur, the Access Control Table keep tracks of the transfers, as ownership of the application can be transferred among and between multiple agents or back and forth between customer and agent. Values (i.e., the AgentID or CustomerId) are inserted accordingly, depending on who is controlling the application. In step 414, the consumer is informed that control of the application has been transferred to an agent (see FIG. 4E). In some embodiments, an email is also sent to both the agent and the consumer.

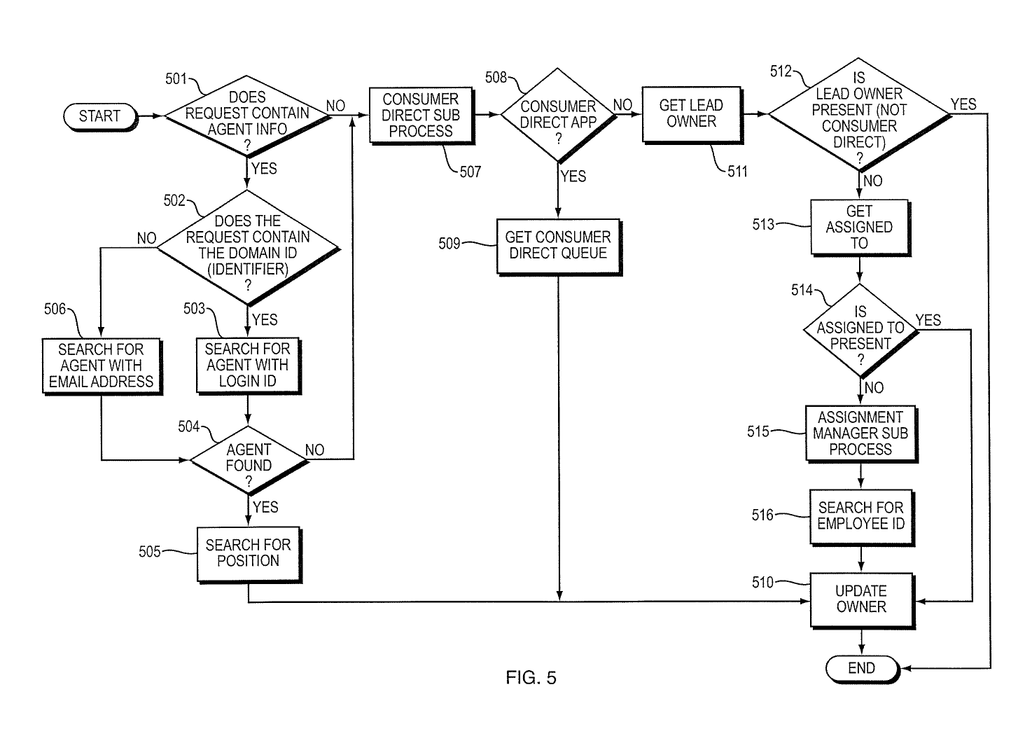

FIG. 5 is a flow diagram illustrating details of the application handover (i.e., steps 404, 405, 406, 411, and 412 of FIG. 4 from the standpoint of the SFA component), in an exemplary embodiment. In step 501, it is determined whether the request includes information identifying the agent. If so, in step 502, it is determined whether the request includes a domain identifier (i.e., the corporate login ID assigned to internal agents. If so, in step 503, the system searches the CRM SFA database for an agent with the matching Login ID. If the request does not include a domain identifier, in step 506, the system searches the CRM SFA database for an agent with a matching email address. In step 504, it is determined if the agent is found, based on the email address or the login ID. If yes, in step 505, a search for the agent details is performed, and the owner is updated from the consumer to the agent in the Access Control Table, in step 510 (step 413 described above). If the agent is not found in step 504, or if the request is found not to include information identifying the agent in step 501, a consumer direct sub process is run, in step 507. This process determines whether the application process was initiated directly by the consumer, without assistance of an agent. In step 508, it is determined whether the application was initiated by the consumer directly. If so, in step 509, the request is placed in a consumer direct queue to be picked up by the next available agent. Upon the next available agent picking up the request, the owner is updated from the consumer to the agent in the Access Control Table, in step 510 (step 413 described above). If, in step 508, it is determined that the application was not initiated by the consumer directly, in step 511, a process is run to get the agent lead owner. If it is determined that the lead owner is present, in step 512, the process ends. If it is determined in step 512 that the lead owner is not present, in step 513 a Get Assigned Process runs to determine if the lead is assigned to any of the agents. In step 514, it is determined if the application is already assigned to some other agent. If yes, the owner of the application is updated in step 510, as described previously. If no, in step 515, an Assignment Manager Sub Process is run to assign the open lead to any of the agents. In step 516, the employee ID is searched (i.e., based on the assignment of lead to an agent, the AgentID is looked up, and, in step 510, the owner is updated in step 510.

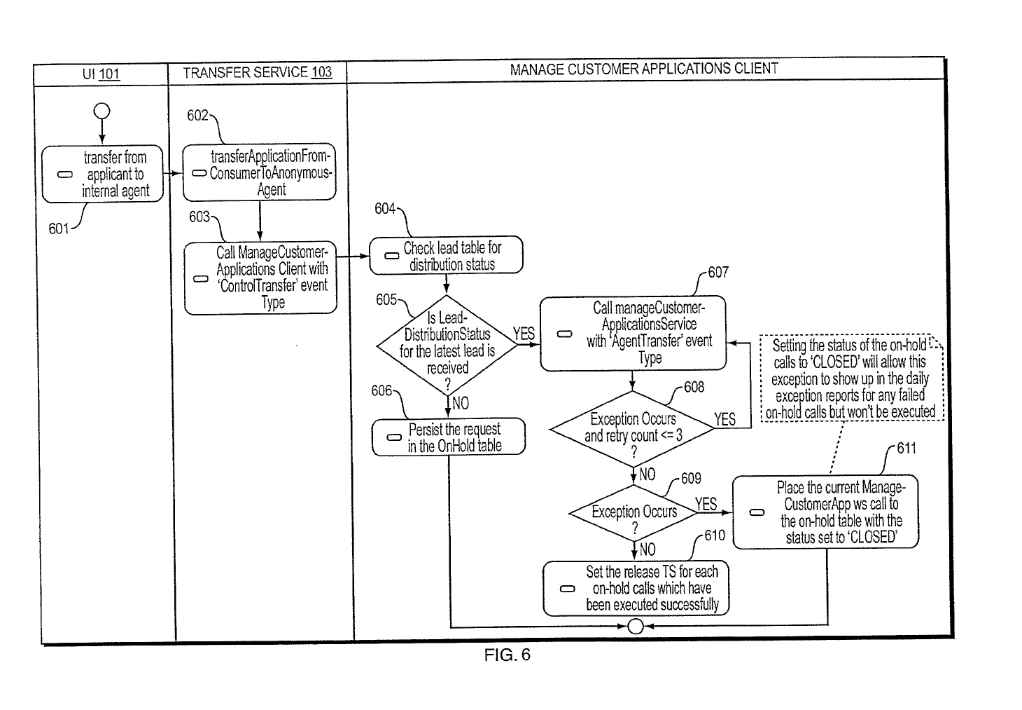

FIG. 6 is a flow diagram illustrating the steps involved in checking the lead status of the application (i.e., step 402), in an exemplary embodiment. In step 601, the application is transferred from the applicant to an internal agent. In step 602, the Transfer Application From Consumer To Anonymous Agent service is invoked. In step 603, a call is made to Manage Customer Applications Client with “Control Transfer” as the event type. In step 604, the lead table is checked for distribution status. In step 605, it is determined if the Lead Distribution Status for the latest lead has been received. If not, the request is persisted in the On Hold table (within the CRM SFA system), in step 606. If it has been received, in step 607 a call is made to the Manage Customer Application Service with the event type as “Agent Transfer.” In step 608, it is determined whether an exception occurs and whether the reentry count is greater than or equal to, e.g., 3. This refers to an exception handling process. For example, there might be an instance in which the lead is not updated timely before step 607 is completed; the system would try, e.g., 3 times before logging the lead as closed. If not, it is determined whether an exception has occurred, in step 609. If not, in step 610, the release TS for each on-hold call that have been executed successfully is set. If so, the current Manage Customer Application call is placed in the on-hold table with the status set to Closed, in step 611. This will allow the exception to show up on the daily exception report for any failed on-hold calls, but will not be executed.

With reference to FIG. 4F, an exemplary internal UI employed by the CSRs is now illustrated. Control over an application in progress may be transferred by the agent to the consumer. In particular, the CSR may click on the “Transfer” button. With reference to FIG. 4G, the CSR inputs the consumer's email address. Upon receiving an email from the system (e.g., using the transfer service component 103 of FIG. 1), with reference to FIG. 4H, the consumer may click on the link provided to access (and submit) his application. Access to the application can be gained, after clicking the link, by entering a PIN and DOB (see FIG. 4I).

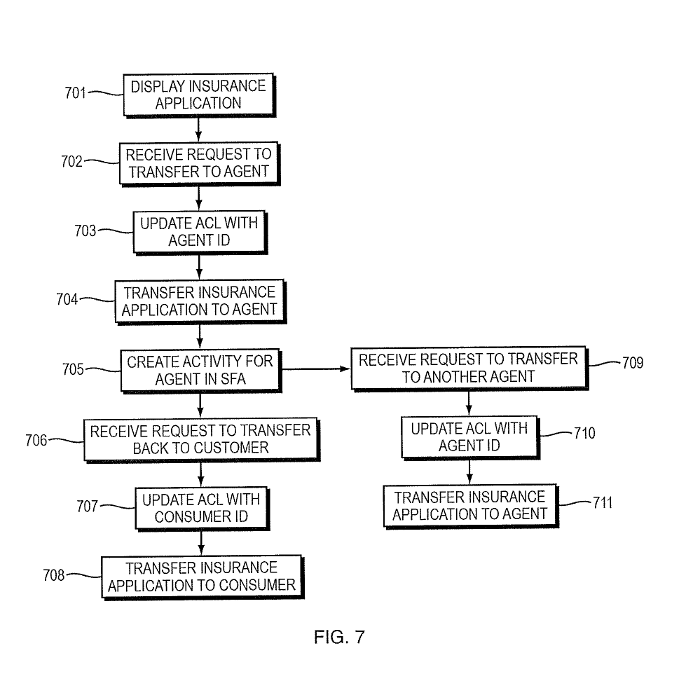

FIG. 7 illustrates an exemplary flow chart in accordance with one embodiment of the present invention. In step 701, an electronic insurance application form comprising a plurality of form fields for receiving input data is displayed to a consumer. Control over input of data to the form fields is associated with an identifier of the consumer in an access control table for the electronic insurance application form. In step 702, a request to transfer control over input of data to the form fields to an insurance agent (one identified by the consumer or the next available agent) is received from the consumer. In step 703, the access control table for the electronic insurance application form is updated to associate control over input of data to the form fields with an identifier of the insurance agent. In step 704, data describing the electronic insurance application form is transferred to the insurance agent. In step 705, an activity for the insurance agent relating to completion of the electronic insurance application form is created in a sales force automation system.

In step 706, in some embodiments, a request to transfer control over input of data to the form fields back to the consumer is received from the insurance agent. In this embodiment, in step 707, the access control table for the electronic insurance application form is updated to associate control over input of data to the form fields with the identifier of the consumer and, in step 708, data describing the electronic insurance application form is transferred to the consumer.

In some embodiments, in step 709, a request to transfer control over input of data to the form fields to another insurance agent is received from the insurance agent. In these embodiments, in step 710, the access control table for the electronic insurance application form is updated to associate control over input of data to the form fields with an identifier of the other insurance agent and, in step 711, data describing the electronic insurance application form is transferred to the other insurance agent.

Control over the application may be transferred multiple times between and among the consumer and the agent(s) in accordance with the present invention.

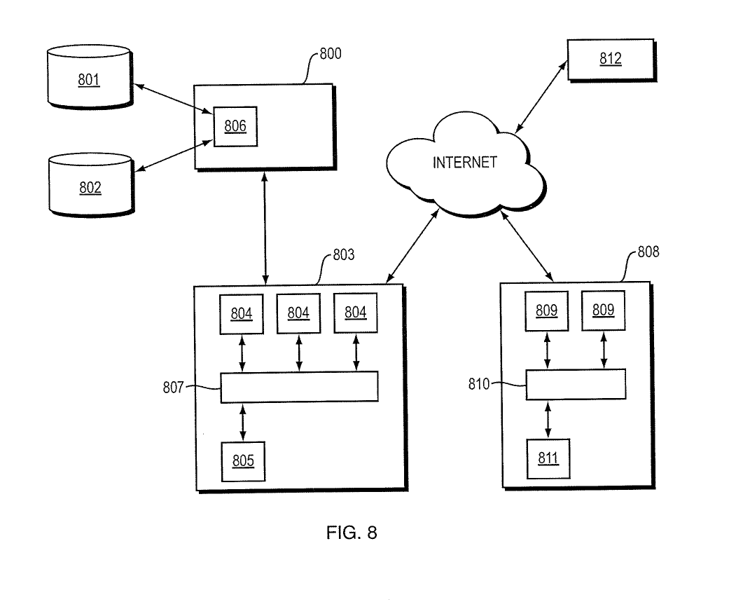

The systems described herein comprise a number of different hardware and software components. Exemplary hardware and software that can be employed in connection with that system are now generally described with reference to FIG. 8. Database server(s) 800 may include a database services management application 806 that manages storage and retrieval of data from the database(s) 801, 802 (such as, e.g., online store database 300). The databases may be relational databases; however, other data organizational structure may be used without departing from the scope of the present invention. One or more application server(s) 803 are in communication with the database server 800. The application server 803 communicates requests for data to the database server 800. The database server 800 retrieves the requested data. The application server 803 may also send data to the database server for storage in the database(s) 801, 802. The application server 803 comprises one or more processors 804, computer readable storage media 805 that store programs (computer readable instructions) for execution by the processor(s), and an interface 807 between the processor(s) 804 and computer readable storage media 805. The application server may store the computer programs referred to herein.

To the extent data and information is communicated over the Internet (e.g., by a consumer employing the online store UI), one or more Internet servers 808 may be employed. The Internet server 808 also comprises one or more processors 809, computer readable storage media 811 that store programs (computer readable instructions) for execution by the processor(s) 809, and an interface 810 between the processor(s) 809 and computer readable storage media 811. The Internet server 808 is employed to deliver content that can be accessed through the communications network. When data is requested through an application, such as an Internet browser, the Internet server 808 receives and processes the request. The Internet server 808 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed using a processor.

What is claimed is:

1. A computer implemented method comprising:
displaying to a consumer an electronic insurance application form comprising a plurality of form fields for receiving input data, wherein control over input of data to the form fields is associated with an identifier of the consumer in an access control table for the electronic insurance application form;
receiving from the consumer a request to transfer control over input of data to the form fields to an insurance agent;
updating the access control table for the electronic insurance application form to associate control over input of data to the form fields with an identifier of the insurance agent; and
transferring data describing the electronic insurance application form to the insurance agent.

2. The method of claim 1 wherein the receiving step comprises:
receiving from the consumer a request to transfer control over input of data to the form fields to a specific insurance agent identified by the consumer.

3. The method of claim 1 wherein the receiving step comprises:
receiving from the consumer a request to transfer control over input of data to the form fields to a next available insurance agent.

4. The method of claim 1 further comprising:
creating an activity for the insurance agent relating to completion of the electronic insurance application form in a sales force automation system.

5. The method of claim 1 wherein at least some data has been input into the form fields of the electronic insurance application prior to transfer to the insurance agent.

6. The method of claim 1 further comprising:
receiving from the insurance agent a request to transfer control over input of data to the form fields back to the consumer;
updating the access control table for the electronic insurance application form to associate control over input of data to the form fields with the identifier of the consumer; and
transferring data describing the electronic insurance application form to the consumer.

7. The method of claim 6 wherein at least some data has been input into the form fields of the electronic insurance application form prior to transfer back to the consumer.

8. The method of claim 1 further comprising:
receiving from the insurance agent a request to transfer control over input of data to the form fields to another insurance agent;
updating the access control table for the electronic insurance application form to associate control over input of data to the form fields with an identifier of the other insurance agent; and
transferring data describing the electronic insurance application form to the other insurance agent.

9. The method of claim 8 wherein at least some data has been input into the form fields of the electronic insurance application form prior to transfer to the other insurance agent.

10. The method of claim 9 further comprising:
creating an activity for the other insurance agent relating to completion of the electronic insurance application form in a sales force automation system.

11. A non-transitory computer-readable storage medium that stores instructions which, when executed by one or more processors, cause the one or more processors to perform a method comprising:
displaying to a consumer an electronic insurance application form comprising a plurality of form fields for receiving input data, wherein control over input of data to the form fields is associated with an identifier of the consumer in an access control table for the electronic insurance application form;
receiving from the consumer a request to transfer control over input of data to the form fields to an insurance agent;
updating the access control table for the electronic insurance application form to associate control over input of data to the form fields with an identifier of the insurance agent; and
transferring data describing the electronic insurance application form to the insurance agent.

12. The non-transitory computer-readable storage medium of claim 11 wherein the receiving step comprises:
receiving from the consumer a request to transfer control over input of data to the form fields to a specific insurance agent identified by the consumer.

13. The non-transitory computer-readable storage medium of claim 11 wherein the receiving step comprises:
receiving from the consumer a request to transfer control over input of data to the form fields to a next available insurance agent.

14. The non-transitory computer-readable storage medium of claim 11 the method further comprising:
creating an activity for the insurance agent relating to completion of the electronic insurance application form in a sales force automation system.

15. The non-transitory computer-readable storage medium of claim 11 wherein at least some data has been input into the form fields of the electronic insurance application prior to transfer to the insurance agent.

16. The non-transitory computer-readable storage medium of claim 11 the method further comprising:
receiving from the insurance agent a request to transfer control over input of data to the form fields back to the consumer;
updating the access control table for the electronic insurance application form to associate control over input of data to the form fields with the identifier of the consumer; and
transferring data describing the electronic insurance application form to the consumer.

17. The non-transitory computer-readable storage medium of claim 16 wherein at least some data has been input into the form fields of the electronic insurance application form prior to transfer back to the consumer.

18. The non-transitory computer-readable storage medium of claim 11 the method further comprising:
receiving from the insurance agent a request to transfer control over input of data to the form fields to another insurance agent;
updating the access control table for the electronic insurance application form to associate control over input of data to the form fields with an identifier of the other insurance agent; and
transferring data describing the electronic insurance application form to the other insurance agent.

19. The non-transitory computer-readable storage medium of claim 18 wherein at least some data has been input into the form fields of the electronic insurance application form prior to transfer to the other insurance agent.

20. The non-transitory computer-readable storage medium of claim 19 the method further comprising:
creating an activity for the other insurance agent relating to completion of the electronic insurance application form in a sales force automation system.

21. A system comprising:
memory operable to store at least one program; and
at least one processor communicatively coupled to the memory, in which the at least one program, when executed by the at least one processor, causes the at least one processor to:
display to a consumer an electronic insurance application form comprising a plurality of form fields for receiving input data, wherein control over input of data to the form fields is associated with an identifier of the consumer in an access control table for the electronic insurance application form;
receive from the consumer a request to transfer control over input of data to the form fields to an insurance agent;
update the access control table for the electronic insurance application form to associate control over input of data to the form fields with an identifier of the insurance agent; and
transfer data describing the electronic insurance application form to the insurance agent.

22. The system of claim 21 wherein receive comprises:
receive from the consumer a request to transfer control over input of data to the form fields to a specific insurance agent identified by the consumer.

23. The system of claim 21 wherein receive comprises:
receive from the consumer a request to transfer control over input of data to the form fields to a next available insurance agent.

24. The system of claim 21 wherein the processor is further caused to:
create an activity for the insurance agent relating to completion of the electronic insurance application form in a sales force automation system.

25. The system of claim 21 wherein at least some data has been input into the form fields of the electronic insurance application prior to transfer to the insurance agent.

26. The system of claim 21 wherein the processor is further caused to:
receive from the insurance agent a request to transfer control over input of data to the form fields back to the consumer;
update the access control table for the electronic insurance application form to associate control over input of data to the form fields with the identifier of the consumer; and
transfer data describing the electronic insurance application form to the consumer.

27. The system of claim 26 wherein at least some data has been input into the form fields of the electronic insurance application form prior to transfer back to the consumer.

28. The system of claim 21 wherein the processor is further caused to:
receive from the insurance agent a request to transfer control over input of data to the form fields to another insurance agent;
update the access control table for the electronic insurance application form to associate control over input of data to the form fields with an identifier of the other insurance agent; and
transfer data describing the electronic insurance application form to the other insurance agent.

29. The system of claim 28 wherein at least some data has been input into the form fields of the electronic insurance application form prior to transfer to the other insurance agent.

30. The system of claim 29 wherein the processor is further caused to:
create an activity for the other insurance agent relating to completion of the electronic insurance application form in a sales force automation system.
